(19) United States
(12) Patent Application Publication
(10) Pub. No.: US 2022/0000703 A1
(43) Pub. Date: Jan. 6, 2022

(54) OPTIMIZED ANKLE EXOSKELETON FOOT PLATE FUNCTION AND GEOMETRY

(71) Applicant: Arizona Board of Regents on Behalf of Northern Arizona University, Flagstaff, AZ (US)

(72) Inventors: Zachary F. Lerner, Flagstaff, AZ (US); James Babers, Flagstaff, AZ (US)

(21) Appl. No.: 17/365,768

(22) Filed: Jul. 1, 2021

Related U.S. Application Data
(60) Provisional application No. 63/047,152, filed on Jul. 1, 2020.

(51) Int. Cl. A61H 3/00; B25J 9/00

(52) U.S. Cl. CPC A61H 3/00; A61H 2201/1642; A61H 2201/1215; B25J 9/0006

(57) ABSTRACT

A foot plate for an assistive device is disclosed. The foot plate includes a planar vertical mounting portion on its lateral side, and a planar foot bed. The foot plate includes a gradual shoulder portion, such as a web of material that ties the vertical mounting portion to the foot bed. The foot plate also includes a heel cup at a posterior end for engaging the heel of a user. The foot plate also includes a rocker portion underneath the toes of a user, on an anterior end of the foot plate. The rocker portion enables the toes to flex in the dorsal direction during walking without the foot becoming disengaged from the foot plate.

### CROSS-REFERENCE TO RELATED APPLICATIONS

This application claims priority to U.S. Provisional Application 63/047,152 entitled “Optimized Ankle Exoskeleton Foot Plate Function and Geometry” filed on Jul. 1, 2021, the disclosure of which is incorporated in its entirety herein by reference.

### STATEMENT CONCERNING FEDERALLY-FUNDED RESEARCH

This invention was made with government support under Grant No. 12736112 awarded by the National Institutes of Health. The government may have certain rights in the invention.

### BACKGROUND OF THE INVENTION

A number of injuries or conditions can lead to disorders that affect muscle control. Individuals with muscle control disorders frequently experience a downward trend of reduced physical activity and worsening of gait function leading to a permanent decline in ambulatory ability. Lower-limb wearable assistive devices have been shown to improve gait patterns and walking economy in individuals with neurological conditions such as cerebral palsy or stroke. These devices provide mobility enhancement by applying assistive joint torque through the gait cycle. Existing devices use a variety of design approaches to accomplish this fundamental aim. These devices may include Bowden cable actuation, direct-drive shank mounted motors, fabric shank interfaces, bilateral carbon fiber frames, and lateral lower leg structures.

These devices also generally include foot plates to direct torsional force provided at the angle toward the ground, or additionally alternatively, to resist torsional forces imparted by the user's ankle joint. The foot plate is located beneath the user's foot, and between the user's foot and the ground, typically on the foot bed of a shoe worn by the user. In addition to constituting a force transmitting interface between the user's foot and the ground, the foot plate typically carries one or more sensors, such as pressure sensors, which may measure the force being applied to the foot plate or the ground by the user of the device. Inventive embodiments described below represent improvements over such existing devices.

### BRIEF SUMMARY

This disclosure is directed to a mechanical design for an exoskeleton foot plate component. The component advantageously permits the reduction of the size and physical profile of exoskeletons mounted laterally to human joints like the ankle, while simultaneously increasing strength, reliability, durability and torque transfer. Embodiments of the invention are directed to a laterally actuated foot plate that generates distal ankle torque reaction forces to provide dorsiflexion and plantarflexion while minimizing distal mass, gait interference, and exoskeleton interface discomfort. The disclosure describes foot plates that are stronger, more rigid, lighter, more durable and more ergonomic than conventional designs.

Embodiments of the invention are directed to an improved foot plate usable with, for example, a powered orthosis for assisting with ankle motion. Inventive embodiments include a laterally actuated foot plate component that is used to convert exoskeleton ankle joint torque into assistive propulsion, or resistive training stimulus. In exemplary embodiments, the foot plate includes a vertical mounting portion on the foot plate's lateral side, which enables the foot plate to be mounted to a medial side of a mounting member. The mounting portion is located on a medial side of a user's ankle. The mounting member may be part of a laterally actuated assistive device. Such a device is disclosed in co-pending, co-owned U.S. patent application Ser. No. 17/343,628, which is incorporated by reference herein in its entirety.

An exemplary foot plate according to an inventive embodiment includes a foot bed coupled to the mounting portion with an oblique planar (i.e., a plane angled to bridge between the vertical mounting portion and a horizontal portion of the foot bed) or curved transition section. At a posterior side of the foot bed is located a heel cup, which is also coupled to the mounting portion. The heel cup wraps around a posterior surface of the heel of a user. The heel cup includes an upper edge that defines a gradual shoulder portion that connects the vertical mounting portion and the foot bed of the foot plate.

In an exemplary footplate according to an inventive embodiment, the foot bed includes a planar portion and a fore-foot, posterior portion. The fore-foot portion is connected to the planar portion, but is angled or curved in an upward or superior direction relative to the planar portion. In certain embodiments, the fore-foot foot bed portion is a plane that is angled in an upward or superior direction. In other embodiments, the fore-foot foot bed portion is smoothly curved in an upward or superior direction, such that the foot bed in total resembles a ski jump. The foot bed in certain embodiments, having its planar and fore-foot portions, is configured and sized such that the foot bed transitions from its planar portion to the upward sloping portion in the vicinity of the distal ends of the user's metatarsal bones, i.e., the major joint of the toes.

In a first aspect, embodiments include a foot plate for an assistive device. The foot plate has a vertical mounting portion arranged on a lateral side of an ankle of a user. The foot palte also has a planar foot bed portion having a heel portion at a posterior end, a forefoot portion at an anterior end, and a mid-foot portion between the heel and forefoot portions. The foot bed has a dorsal surface arranged to be orthogonal to planar vertical mounting portion. The foot plate also includes a heel cup at the foot bed's posterior end, the heel cup having a curved surface that is concave toward the anterior end of the foot bed. The foot plate also has a shoulder portion arranged on a lateral side of the foot bed, the shoulder portion connecting the vertical mounting portion to the forefoot portion of the foot bed.

In another aspect, embodiments include a wearable assistive device. The device includes an extended, tubular structural member having a closed circumferential cross section, a first end and a second end defining a long axis through a center of the extended structural member. The device also has a rotational bearing disposed within the extended structural member and positioned on the long axis near the second end of the extended structural member. The device also includes an extension cable having a first end coupled to an actuator and a second end coupled to the rotational bearing, and a retraction cable having a first end coupled to the actuator and a second end coupled to the rotational bearing. When the extension cable is pulled toward the actuator, the rotational bearing experiences a torque that tends to rotate the rotational bearing in a first direction, and when the retraction cable is pulled toward the actuator, the rotational bearing experiences a torque that tends to rotate the rotational bearing in a second direction. The device also has a foot plate coupled to a medial side of the rotational bearing and dimensioned to support the foot of a user. The foot bed has a planar dorsal surface, and it extends medially from the rotational bearing and the structural member. The foot plate also has a heel cup having a curved portion arranged at an anterior side of the foot plate, and extending vertically up from the dorsal surface of the foot plate.

In another aspect, embodiments include a foot plate for an assistive device. The foot plate has a planar vertical mounting portion arranged on a lateral side of an ankle of a user. The foot plate also has a planar foot bed portion having a heel portion at a posterior end, a forefoot portion at an anterior end, and a mid-foot portion between the heel and forefoot portions. The foot bed has a planar dorsal surface arranged to be orthogonal to planar vertical mounting portion. The foot bed also has an upwardly sloping toe portion, anterior to the to the forefoot portion of the foot bed, the upwardly sloping toe portion having a dorsal surface that slopes upwardly away from the planar dorsal surface of the foot bed.

Systems using foot plates according to inventive embodiments have certain advantages. In existing powered devices for ankle motion assistance, the foot beds provided are entirely planar. During the toe off stage of a normal step, a user's toes will deflect in a superior direction (relative to the forefoot) creating an acute angle between the toes and the forefoot. For an entirely planar foot bed, this will tend to cause the heel to come off of the foot bed as the toes press down on the planar foot bed. This is disadvantageous because the foot will repeatedly slap against the foot bed during walking, the function of the device becomes apparent, cumbersome and uncomfortable to the user, and force transfer from the device to the ground may be less efficient.

This problem is sometimes addressed in existing devices by shortening the foot bed such that it ends at the distal end of the forefoot, before the toes. This solution is disadvantageous because, first, this may require moving the foot bed's pressure sensor in a posterior direction such that it is not located beneath the “ball” of the foot, which is the user's foot's biological center of pressure and the best place to measure the force the user is imparting to the foot bed. Additionally, a shorter foot bed prevents the foot bed from applying force to the ground beneath the ball of user's foot, which is the most efficient place to push off the ground, and the most natural and transparent means of providing assistance from the user's perspective since this location is the natural center of biological pressure. As a matter of mechanics, pushing off the ground with a shorter foot bed is less efficient, and a shortened foot bed requires the assistive device to supply more torque to the ankle to provide the same amount of force to the ground relative to a longer foot bed. This, in turn, may require larger, heavier, more powerful motors and batteries, overbuilt drive components, and may result in a louder, less transparent assistive device with a shortened lifetime.

The foot plate of certain inventive embodiments overcomes these disadvantageous by sloping upward at the forefoot and beyond to accommodate toe deflection during the toe off portion of the gait cycle. This allows the foot plate to roll forward during the propulsive phase of the gait, such that the entirety of the sole of the foot is in contact with the foot plate throughout the movement. Inventive embodiments accomplish this without inordinately shortening the foot plate, which would move the assistive or resistive center of pressure posterior to the user's biological center of pressure.

Systems including foot plates according to inventive embodiments have further advantages over existing systems. Existing assistive devices often incorporate bilateral frames having metal, polymer or carbon fiber vertical components arranged on both a medial and a lateral side of a user's leg or legs. Such bilateral frames often suffer from overlarge medial and posterior lower envelopes, resulting in terrain restrictions, increases in step width, and contralateral limb collision or clipping during walking. User's often adjust to these problems by adopting an unnatural gait, e.g., an unnaturally wide gait, which is advantageous, particular in a resistive training or rehabilitation setting where the goal is for the user to eventually adopt a normal gait without need of the device. Other systems, incorporating shank mounted direct-drive transmission systems reduce complexity but increase distal mass, reducing metabolic performance and efficiency. Fabric shank interfaces rely on friction with the skin, and so are prone to slippage, and transfer reaction forces to the ground through the body instead of the device. Such systems are also ill suited to warmer climates where they may be uncomfortable and their performance may be compromised by the user's sweat.

Some of these disadvantages may be overcome with systems having rigid, laterally configured lower leg assemblies (i.e., assemblies where the components are located lateral to the lower limb). Such devices eliminate the negative gait outcomes associated with posterior and medially-protruding features. When provided with Bowden cable force transmission components, such devices can also support the Bowden cable reaction forces. Such systems must be configured, however, to resist axial bending and maintain torsional stiffness. A system that is sufficiently rigid and strong in this regard is described in co-pending, co-owned U.S. patent application Ser. No. 17/343,628. That Application describes, inter alia, a system that uses laterally mounted, tubular, vertical members for supporting Bowden cables that supply rotational force to pulleys mounted within the tubular members.

The instant disclosure is directed to further improvements over laterally mounted systems using laterally actuated footplates. In certain laterally mounted systems, even where the vertical member is designed to resist torsional deformation, the medially mounted foot plate will tend to experience torsional forces during use. Specifically, the foot plate, which is mounted to a vertical support member lateral to the user's angle, will tend to twist in a transverse or horizontal plane, causing the user's toes to point laterally or medially. This is disadvantageous, because in a natural gate, a user's feet will move front-and-back in a plane parallel to the body's sagittal plain. Thus, the gate becomes unnatural, and force delivered to the ground is unhelpful, since it is delivered with a medial or lateral component, rather than in a plane parallel to the direction in which the user is walking.

Foot plates according to certain inventive embodiments resist this torsional deformation with an axially stiff mechanical design combined, in some embodiments, with stiff, strong lightweight materials such as carbon fiber.

The above features and advantages of the present invention will be better understood from the following detailed description taken in conjunction with the accompanying drawings.

### BRIEF DESCRIPTION OF THE DRAWINGS

The drawings described herein constitute part of this specification and includes example embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 is a front isometric view of a wearable exoskeleton device; according to some embodiments;

FIG. 2 is a front isometric view of a control unit of the exoskeleton device of FIG. 3, according to some embodiments;

FIG. 3 is a rear isometric view of the exoskeleton device of FIG. 3, according to some embodiments;

FIG. 4 is a side plan view of a lower hinged assembly that is operably coupled with the control unit through a transmission assembly, according to some embodiments;

FIG. 5 is an outer side elevation view and inner side isometric view of a wearable exoskeleton device according to additional embodiments.

FIG. 6 is an elevated view of a medial side of a left foot foot plate according to an embodiment;

FIG. 7 is an elevated view of a medial side of a right foot foot plate according to an embodiment;

FIG. 8 is a front view of a right foot foot plate according to an embodiment;

FIG. 9 is a side view of a medial side of a right foot foot plate according to an embodiment;

FIG. 10 is a depiction of aspects of the device of FIG. 5 being worn on the leg of a ser.

FIG. 11 is another depiction of aspects the device of FIG. 5 being worn on the leg of a user.

### DETAILED DESCRIPTION

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus appearances of the phrase “in one embodiment,” “in an embodiment,” and similar language throughout this specification may, but do not necessarily, all refer to the same embodiment. References to “users” refer generally to individuals accessing a particular computing device or resource, to an external computing device accessing a particular computing device or resource, or to various processes executing in any combination of hardware, software, or firmware that access a particular computing device or resource. Similarly, references to a “server” refer generally to a computing device acting as a server, or processes executing in any combination of hardware, software, or firmware that access control access to a particular computing device or resource.

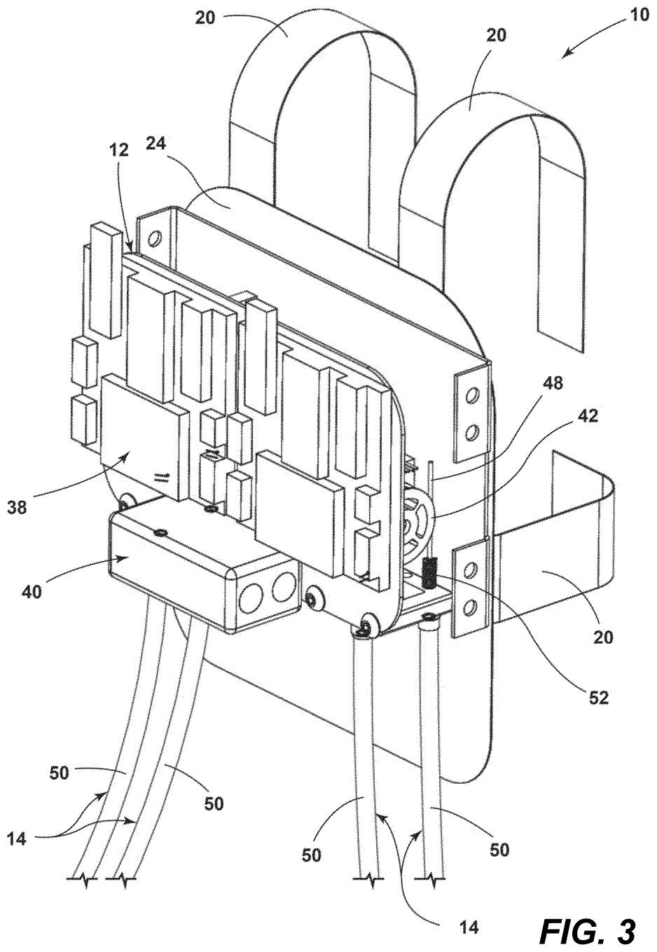

For purposes of description herein, the terms “upper,” “lower,” “right,” “left,” “rear,” “front,” “vertical,” “horizontal,” and derivatives thereof shall relate to the embodiment of the invention as oriented in FIG. 3. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if any assembly or composition is described as containing components A, B, and/or C, the assembly or composition can contain A alone; B alone; C alone; A and B in combination; A and C in combination; B and C in combination; or A, B, and C in combination.

As used herein, the terms “assistance” and “resistance” may be used interchangeably to signify the direction of external torque applied to a joint that may be perceived as augmenting (making a movement easier, assistance) or harder (resistance).

The following disclosure describes exoskeleton devices and methods of utilizing an exoskeleton device to provide powered assistance designed to increase mobility or facilitate rehabilitation in a user. The powered exoskeleton device is a wearable, mobile device that allows a user to perform limb motions with additional external power, for increasing a user's strength or endurance. The powered exoskeleton device may operate specifically to facilitate rehabilitation, providing resistance for targeted and functional strengthening. The device may also operate specifically to increase mobility, providing assistance, aiming to enhance or augment the user's capabilities. The exoskeleton device may be used during daily life and may offer a transformative new option for improving mobility by reducing barriers to physical activity, such as for individuals with neurologically-based gait disorders. The barriers to mobility faced by individuals (e.g. individuals with gait deficits) may include prohibitively high metabolic cost of transport and difficulty completing strength- and balance-intensive weight-bearing tasks such as navigating stairs and around or over obstacles. For improving gait mechanics and walking efficiency, robotic joint (e.g. ankle, knee, hip, and/or any other joint) actuation can provide positive power to the body through appropriately-timed assistance (e.g. extension/contraction assistance). For increasing functional strength, robotic joint actuation may resist a movement or targeted muscle group, including powered resistance that is proportional to the instantaneous demand on the joint (i.e. net muscle moment).

The wearable exoskeleton device enables new methods for improving walking ability. For example, the exoskeleton device provided herein may include techniques (e.g. real-time biofeedback) to encourage favorable changes in volitional muscle activity patterns.

The ankle joint plays a critical role in whole-body stability and forward propulsion during walking. Dynamic ankle actuation and stability control are required for independent and effective function at home and in the community. Assistance at or near the ankle joint appears to provide improvement in walking economy and has the potential to reduce the metabolic cost of transport. Likewise, dynamic or intermittent actuation and stability of a knee joint can also be required, which may be improved by providing assistance at or near the joint. Other movements of the body may likewise be improved by providing assistance near various other joints of the body. This type of powered assistance may seek to maintain and ultimately augment the wearer's range of motion and muscle strength. Furthermore, by offering the potential to reduce the metabolic cost of activity (e.g. walking), powered joint assistance may lead to increases in habitual physical activity.

In some embodiments, for improving gait mechanics and walking efficiency, robotic actuation can provide positive power to the body through appropriately-timed assistance (e.g. plantar-flexion assistance) during the walking process.

For improving performance during balance-intensive tasks, an exoskeleton device (e.g. an ankle exoskeleton device) can respond rapidly to perturbations or abrupt changes in posture by modulating joint torque, and therefore joint impedance, in real-time, to help maintain balance.

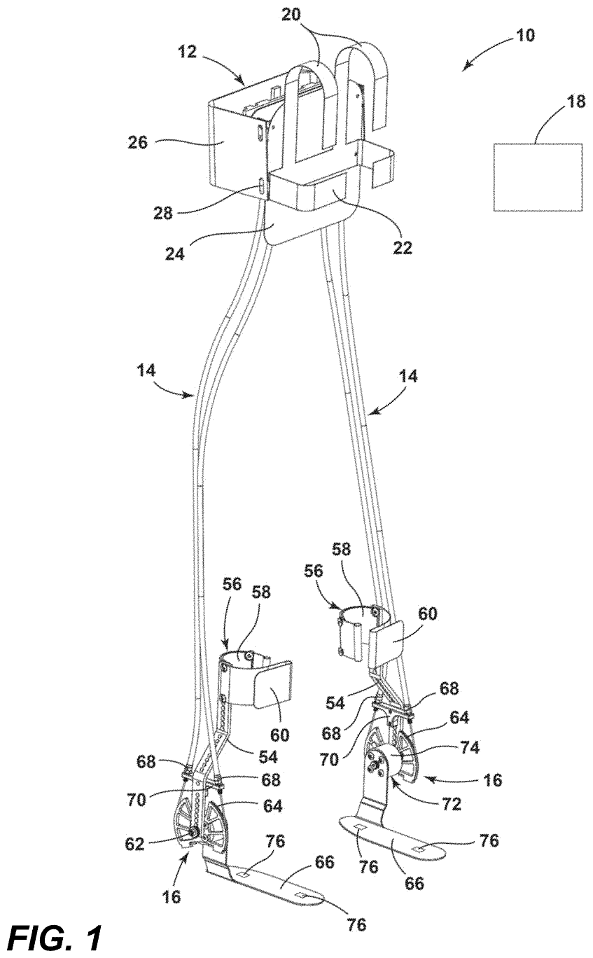

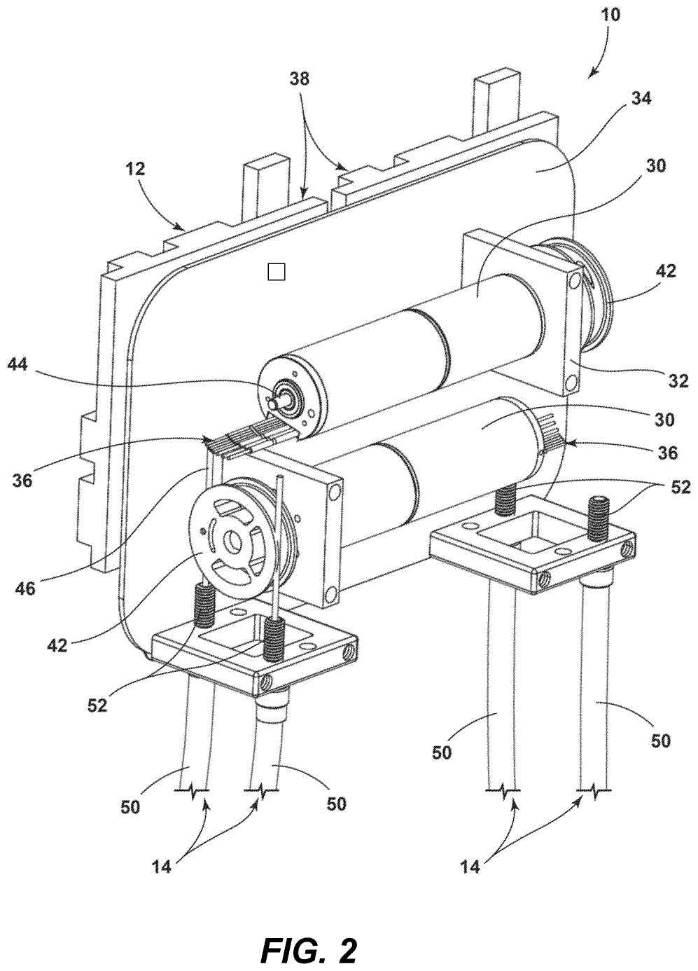

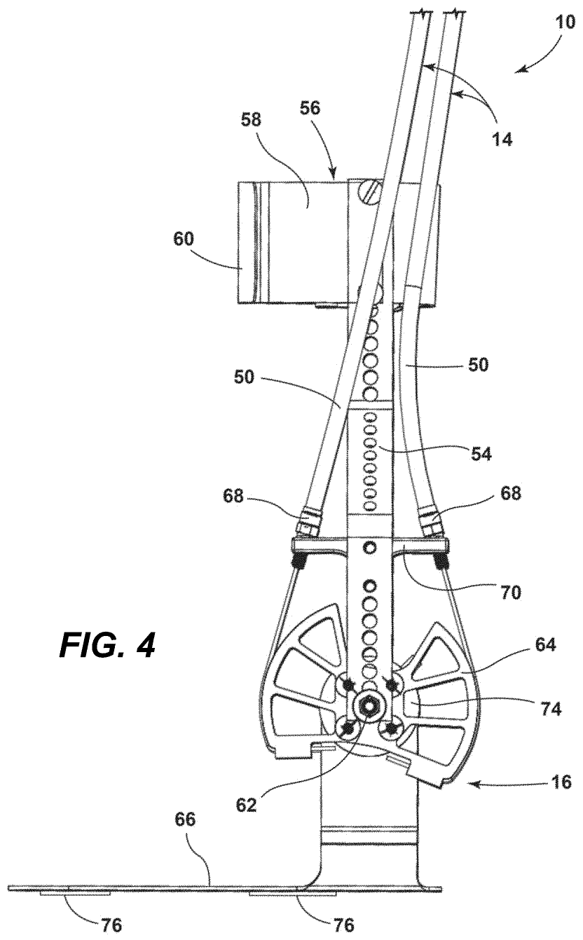

In some embodiments, an exoskeleton device may provide assistance during some modes of operation intended to improve mobility or posture in the form of linear force and/or rotational force (i.e. torque). Alternatively, the exoskeleton may provide resistance a mode of operation designed to increase muscle recruitment during a function task (e.g. walking) in the form of linear force and/or rotational force (i.e. torque). The assistance or resistance may be provided to various hinged assemblies of the exoskeleton device. The electronic assistance may be provided by a powered ankle-foot orthosis (AFO), a knee assembly, and/or any other joint assembly that is coupled with a control unit through a transmission assembly. For example, FIGS. 1-4 illustrate various embodiments of the exoskeleton device 10 that includes a control unit 12, a transmission assembly 14, and a pair of hinged assemblies 16. In the illustrated embodiment, the exoskeleton device 10 includes two lower hinged assemblies 16 for a right foot and a left foot of a user. Each of the lower hinged assemblies 16 is configured as an AFO.

In some embodiments, the exoskeleton device 10 may also include a feedback modality 18 for providing feedback regarding the individual's use of a wearable exoskeleton device 10 in a free-living environment. In some instances, a method for providing feedback to an individual using a prosthesis utilizes a computer monitor mounted at line-of-sight in front of a treadmill that provides a near real-time visual display of desired biomechanical parameters and the individual's compliance or non-compliance with these parameters. However, as can readily be determined, this type of feedback can be incompatible with use outside of a rehabilitation facility and in free-living settings. Accordingly, in some embodiments, the exoskeleton device 10 may utilize other methods for providing feedback that include auditory feedback via speakers or headphones or earbuds, vibrotactile feedback via small vibration actuators, and/or wearable visual feedback via body-warn displays (e.g. wrist mounted monitor or LEDs).

In the embodiment illustrated in FIGS. 1-4, a control unit 12 includes attachment straps 20 used to attach the control unit 12 to an individual or a user (e.g. along a user's back). In some examples, the straps 20 may include first and second vertical straps along with a waist strap. Any of the straps 20 may be attached to one another on one or both end portions thereof. Moreover, the waist strap may include a buckle 22 that allows for engagement of two end portions of the strap and adjustability as to the length of the strap 20. The straps 20 may be flexible or rigid. The attachment straps 20 may additionally or alternatively be of a waist strap form, a backpack form, or any other structure for supporting weight on the user's waist, torso, or other attachment site.

In the embodiment of FIGS. 1-4, the attachment straps 20 are operably coupled to a base plate 24. The base plate 24 may provide a surface for mounting or supporting components of the control unit 12 such as a housing shell 26, which may serve to cover or protect internal components of the control unit 12 from direct view or interference. The housing shell 26 may include be formed from covering material (e.g. plastic, aluminum, cloth) suitably arranged to cover the control unit 12 and can have any design disposed thereon. The base plate 24 may be coupled to the housing shell 26 by a plate-to-housing attachment feature 28. This plate-to-housing attachment feature 28 may include correspond engagement features and/or removable fasteners, with examples including bolts, magnets, clips, and slots. In some embodiments, the base plate 24 and the housing shell 26 may be embodied as an integral component, which may include a single piece or multiple pieces.

The control unit 12 may include one or more actuators 30 that can be supported on the actuator base plate 24. The one or more actuators 30 may generate force through a rotary electric motor, linear electric motor, hydraulic piston, pneumatic piston, pneumatic bladders, combinations thereof, and/or any other device capable of generating a force. The one or more actuators 30 are coupled to the base plate 24 through one or more brackets. The one or more actuator brackets 32 may be formed from a metallic, polymeric, or other suitable material for securing the one or more actuators 30 to the base plate 24. A top plate 34 may be positioned on an opposing side of the one or more actuators 30 from the base plate 24. The one or more actuator brackets 32 may attach to the base plate 24, the one or more actuators 30, or to the top plate 34 through removable or non-removable fasteners (e.g., bolts, clips, slots).

Actuator wiring 36 may electrically couple with the one or more actuators 30 and is configured to carry electrical power or electrical control signals to and from the one or more actuators 30 to a circuit board 38 and/or components thereof. The one or more circuit boards 38 may include one or more printed circuit boards (PCBs), mounting one or more circuits or chips, for performing one or more functions described herein. The one or more circuit boards 38 may be removably or non-removably coupled to the top plate 34 through fasteners, such as bolts, clips, slots, or other fasteners. In an alternate embodiment, the one or more circuit boards 38 may be coupled to one or more other components within the control unit 12.

The circuit board can include various electrical components, such as memory, processors, controllers, transceivers, and/or any other device. The various electrical components may have power supplied thereto by one or more batteries that are also supported by the control unit. For example, in the embodiment illustrated in FIGS. 1-4, one or more batteries 40 are coupled to the top plate 34, to the circuit board 38, or to any other component of the control unit 12 by removable or non-removable attachments (e.g. brackets or bolts). The one or more batteries 40 may be any device capable of storing and delivering electrical power, with examples including nickel cadmium, nickel metal hydride, lithium ion, lead acid, alkaline, lithium batteries, and so on. The one or more batteries 40 may be rechargeable or single use. The control unit 12 may further include circuitry and components for connecting and rectifying external electrical power received from external sources to recharge the one or more batteries 40, in some embodiments.

The first actuator can include a first shaft extending therefrom and the second actuator includes a second shaft extending therefrom, the first and second shafts extending in substantially opposing directions within the control unit. Each actuator can be coupled to one or more pulleys or other devices for assisting in translating movement of the actuator to a movement in a different direction. For example, in the embodiment illustrated in FIGS. 1-4, one or more actuator pulleys 42 are double-wrap side-hole pulleys. The pulleys 42 are generally axially aligned with a shaft 44 of the actuator 30 and rotates in conjunction with each respective actuator 30. In some embodiments, the one or more actuator pulleys 42 may be any suitable device for transferring force from the one or more actuators 30 to a transmission assembly 14.

The force generated by the one or more actuators can be carried by one or more transmission elements of the transmission assembly. The transmission elements are configured to provide force to various elements of the exoskeleton device that can be remote from the control unit. For example, cams, linear shafts, pistons, universal joints, and other force-transferring linkages may be implemented. In embodiment illustrated in FIGS. 1-4, the transmission assembly 14 includes one or more extension cables 46 and one or more contraction cables 48. The extension cables 46 and contraction cables 48 may be arranged to transfer opposing forces due to the suitability of cables for transferring “pulling” forces but not for transferring “pushing” forces. In some embodiments, a single transmission element may be used to transfer opposing (both pushing and pulling) forces.

In the embodiment of FIGS. 1-4, the transmission assembly 14 is routed down one or more legs of a user to reach the lower hinged assembly 16. In the illustrated example, the transmission assembly 14 is lightweight and flexible so as to allow minimal impediment of motion of the knee and hip joints of a user. The AFO may include one or more lubricating fluids or materials, disposed on an element or between two relatively-moving elements to reduce friction and increase efficiency. The extension cables and contraction cables may be formed from any suitable material, with examples including metal, Kevlar, and nylon.

The one or more extension cables and one or more contraction cables may each be housed in a cable sheath. The one or more cable sheaths may serve to support and house the extension cables and contraction cables. In the embodiment illustrated in FIGS. 1-4, the extension cables 46 and contraction cables 48 may be Bowden cables that transfer force via the movement of inner cables relative to a hollow sheath 50 or housing containing the inner cable. The one or more cable sheaths 50 may each be coupled to barrel adjustors 52. The barrel adjustors 52 allow for adjustment of the length of the sheaths 50 to adjust a baseline tension of the extension cables 46 or contraction cables 48. The one or more barrel adjustors 52 may be further coupled to the one or more cable brackets.

In the embodiment illustrated in FIGS. 1-4, each lower hinged assembly 16 includes an upright member 54 that serves as a mounting or support element for the components of the lower hinged assembly 16. Each upright member 54 may be additionally coupled to an orthotic cuff 56. The orthotic cuff 56 may be additionally coupled to a D-ring strap 58 and a Velcro strap 60. The orthotic cuff 56, D-ring strap 58, and Velcro strap 60 may be considered together as an attachment mechanism for coupling the lower hinged assembly 16 to a leg of a user at an attachment site, which may be between an ankle and a knee of the leg of the user.

Each upright member 54 may be additionally coupled to a bearing 62 or joint proximate an opposing end portion from the orthotic cuff 56. The one or more bearings 62 may each be coupled to a sprocket 64. Each of the one or more bearings 62 may serve as a freely-rotating and load-bearing connection between the upright member 54 and the sprocket 64. Each collection of an upright member 54, a sprocket 64, and a bearing 62 may be operably coupled to one another through connecting hardware, such as bolts and nuts or other suitable connecting hardware. The connecting hardware may be disposed through various adjustment holes defined by the upright member 54 for adjustability of the lower hinged assembly 16 based on the user's body type.

In some embodiments, additional brackets are attached to the lower hinged assembly based on the joint that is to be assisted. For example, as illustrated in FIGS. 1-4, one or more insole brackets 66 may be rotatably coupled with the upright member 54. The insole brackets 66 support the foot of the user and received torque that is to be applied to a walking surface of the user. The one or more insole brackets 66 may be formed from a metallic material, a polymeric material, and/or any other suitable rigid material. The one or more insole brackets 66 may be configured to be inserted into a user's footwear using thin elements without external straps.

The cable sheaths 50 may be coupled to the lower hinged assembly 16 by lower barrel adjusters 68 to anchor the lower end portions thereof. The lower barrel adjustors 68 may provide adjustment of the length of the sheaths 50 thereby providing adjustment of the baseline tension of the extension cables 46 or contraction cables 48. The one or more barrel adjustors 68 may be mounted on a support block 70. The one or more support blocks 70 may each be additionally coupled to the upright member 54.

After passing through the barrel adjusters 68 and exiting their sheaths 50, the extension cables 46 and the contraction cables 48 may couple to the sprockets 64. The sprockets 64 may clamp to each of the extension cables 46 and the contraction cables 48 on a first end portion and coupled to a single actuator pulley 42 in the control unit 12 on a second end portion. In various embodiments, an opposing pair may instead embodied in a single element with the capability to transfer both positive and negative forces. In some embodiments, the sprocket 64 may include any device for capturing force from a transmission assembly 14 to produce torque between two or more attachment points with at least one attachment point on each side of a user's joint (e.g., torque between the insole bracket 66 and the orthotic cuff 56).

Each upright member 54 and insole bracket 66, taken in combination, may be considered as a force-applying arm applying torque around an axis. In some instances, the axis is generally aligned with a body joint axis (e.g. an ankle joint axis). When a force is applied along a length of extension cables 46 or contraction cables 48, a force is applied to sprocket 64 and, in turn, insole bracket 66. Accordingly, the forces applied along the lengths of extension cables 46 and contraction cables 48 apply a force causing insole bracket 66 to rotate about the bearing 62 with respect to upright member 54.

In various embodiments, the extension cables 46 and/or the contraction cables 48 can be actuated based on acquired data from one or more sensors 72 within the exoskeleton device 10 in reference to use of the hinged assembly. As provided herein, one or more performance metrics may be determine based on the acquired data, which may include at least one of a posture position, joint positions/angles, joint moment, joint power, or spatiotemporal parameters of walking, including step/stride length and gait speed. In some examples, the one or more sprockets 64 may each be additionally coupled to a torque sensor 74 or a joint angle encoder configured to measure an angle at some point during an individual's gait cycle as the data point. The torque sensor 74 may be used to sense the torque force applied by the exoskeleton device 10 for assistance. The torque sensor 74 may be additionally coupled to the insole bracket 66. In some embodiments, the one or more sprockets 64 may be coupled to the corresponding one or more insole brackets 66 without an intermediate torque sensor 74. Additionally or alternatively, in various embodiments, the sensor 72 may be configured as one or more accelerometers coupled the lower hinged assembly 16 to provide information on the user's gait.

In some embodiments, the sensor 72 may be configured as one or more pressure/force sensors 76 may also be operably coupled with the insole bracket 66. The one or more pressure/force sensors 76 may be positioned on an upwardly and/or a downwardly facing surface of the insole bracket 66 in various embodiments to provide spatial pressure information across the foot surface. The one or more pressure/force sensors 76 may include force-sensitive resistors, piezo resistors, piezoelectrics, capacitive pressure sensors, optical pressure sensors, resonant pressure sensors, or other means of sensing pressure, force, or motion.

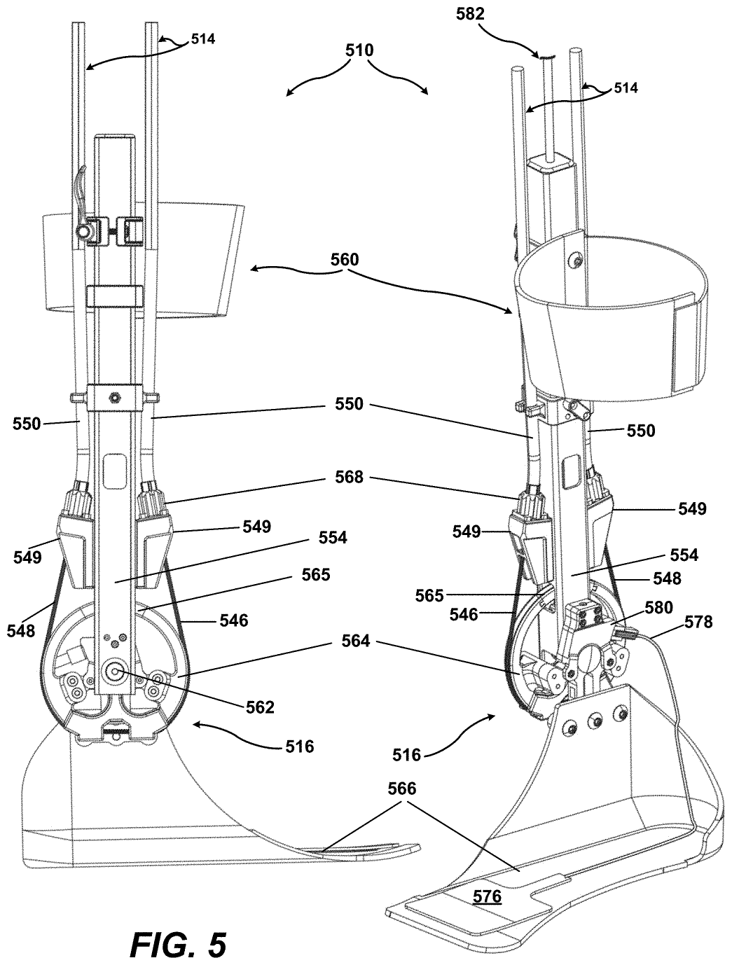

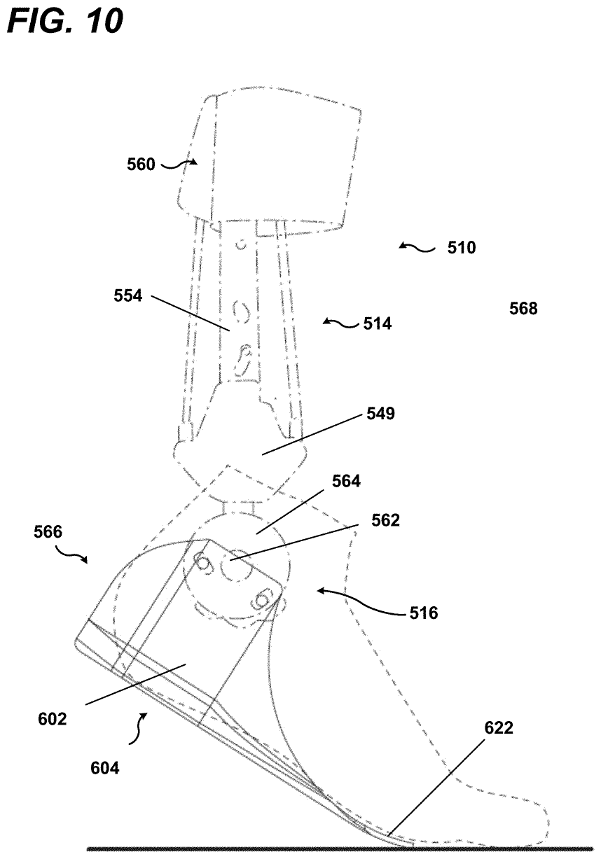

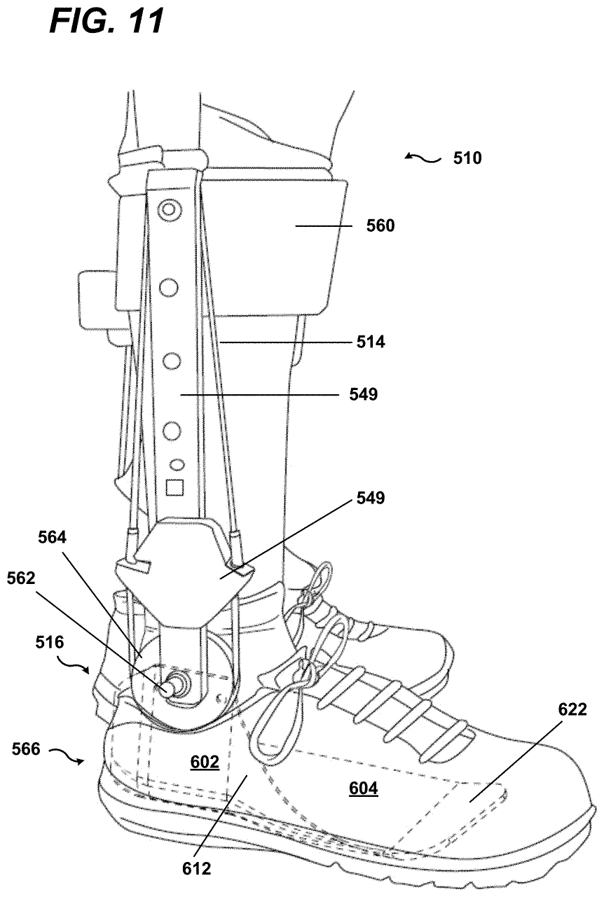

FIGS. 5, 10 and 11 depict a device 510 related to the embodiment(s) of FIGS. 1-4 (e.g., the device 10). It will be understood that descriptions of various components of the device 10 are also applicable to components of the device 510. The interior portion of the device 510 (the portion of the device that rests against the outer leg of a user wearing the device) is visible on the right side of FIG. 5, while the opposite (exterior) side is visible on the left. The device 510 is configured to aid or resist motion of a user's ankle and includes a lower hinged assembly 516 (analogous to the lower hinged assembly 16 of the device 10) that is coupled to an insole bracket 566. The lower hinged assembly 516 and other components are supported by an upright member 554 which may be fastened to the user's calf as shown in FIGS. 10 and 11 using an orthotic cuff 560 (e.g., the cuff 60 of the device 10). As can be seen, member 554 is coupled to orthotic cuff 560 on a lateral side of cuff 560, such that member 554, transmission linkage (e.g., cables), pulley 564, etc., are all located on the lateral side of a user's leg. This prevents the assistive hardware from clipping the hardware on the other leg during walking, which greatly improves natural gait.

The lower hinged assembly 516 includes a pulley 564 mounted to a rotatable bearing 562. The pulley 564 is coupled to transmission assemblies 514 in which cables, wires, chains, cables, and combinations thereof, or similar structures coupled to actuators are passed through a rigid sheath 550 before passing through barrel adjustors 568. Sheath 550 is rigidly mounted to member 554 through illustrated mounts 549. This is accomplished by slotting an extension on barrel adjustor 568 into a receiving structure on mount 549. Extension cable 548 and a contraction cable 546 may be mutually coupled to pulley 564 and configured to rotationally actuate bearing 562. As shown, the pulley 562 is partially mounted within the rigid member 554. When an actuator pulls on the extension cable 548, the foot plate 566 is configured to tend to rotate away from the rigid member to aid in plantar flexion (i.e., a torque is placed on the user's ankle to assist in plantar flexion and/or to resist dorsiflexion). When an actuator pulls on the contraction cable 546, the foot plate 566 is configured to tend to rotate away from the rigid member 554 to aid in dorsiflexion (i.e., a torque is placed on the user's ankle to assist in plantar dorsiflexion and/or to resist plantar flexion).

As in the embodiments set forth above with respect to FIG. 1-4, transmission assemblies 514 may optionally include one or more (and preferably a pair) of Bowden cables, each including an outside sheath 550 and an interior cable 546. The sheath 550 is mounted to mount 549, which is itself mounted to member 554 proximate to pulley 562. In certain embodiments, sheath 550 is sufficiently rigid so as to provide support vertically, in compression, when member 554 and sheath 550 are oriented vertically. This arrangement may be useful in that, in such a vertical orientation, sheath 550 can provide vertical support for structures of the device located above those illustrated, for example, in FIGS. 1-3, such as, for example, a motor for actuating cables, batteries, control electronics, etc.

Foot plate 566 may be provided with a pressure sensor 576 that detects forces exerted by a user's foot on the insole bracket 566. As shown, the pressure sensor includes one or more electrical leads 578 that are routed to a fixture 580 coupled to the hub of the pulley 564. Electrical signals may be carried from the pressure sensor 576 and from other sensors to one or more control units via an electrical cable 582 that may be configured to pass through the interior of the rigid member 554. The fixture 580 may include additional sensors or may be coupled to additional sensors, such as one or more torque sensors configured to produce electrical signals that indicate an amount of torque applied by the device to the ankle of a user wearing the device. As an example, a torque sensor may be coupled to or embedded in the fixture 580. Fixture 580 serves as a mounting interface for foot plate 566, and transfers rotational force from bearing 562 to foot plate 566. Accordingly, by measuring torque or strain applied to fixture 580, the torque being applied by the pulley to the foot plate may be measured and/or calculated. In some embodiments, the sensor includes or more Wheatstone bridges or other resistive strain sensors whose outputs may be used to determine an amount of torque experienced at the user's ankle. It will be understood that any suitable sensor technologies may be used for the pressure sensor(s) 576 and the torque sensor(s), including, but not limited to any suitable optical or electrical sensors. In some embodiments signals from one or more sensors may be transmitted electrically over wires or wirelessly (e.g., using analog or digital radio frequency signaling), or optically via fiber-optic cables, as non-limiting examples.

In the device 510, the pulley 564 is mounted on a bearing 562 secured within the rigid member 554 such that bearing 562 may freely rotate. Rigid member 554 is preferably a tubular member having a hollow interior area with a vertical centerline. Bearing 562 is mounted so that the member 554′s centerline passes though the axis of rotation of bearing 562. This allows the pulley to be mounted centrally in member 554, which in the examples shown is a tubular member having a square cross section, such that the long axis of member 554 passes through bearing 562 and is orthogonal to bearing 562′s axis of rotation. plane.

Referring now to FIGS. 5, 10 and 11, in the preferred examples, device 510 (or more preferably, a pair of devices 510) are mounted on the outside (i.e., the lateral side) of a user's leg, such that pulley 564 is on a lateral side of the user's ankle. This mounting arrangement is advantageous because locating assistive hardware on the inside, or medial side, of the user's legs and feet can cause the hardware to interfere with walking. Such disadvantageous placement often forces a user to adopt an unnatural gait in order to prevent the assistive assemblies of the respective legs from clipping one another during walking. This difficulty is addressed by placing the hardware on the lateral sides of the feet and legs.

It will be appreciated that during operation, pulley 564 is intended to rotate in a vertical plane, i.e., in a plane parallel to the user's sagittal plane. However, as a result of force applied by cables 546 and 548, and loading of foot plate 566, pulley 564 will experience torque tending to deflect pulley 564 out of the plane parallel to the user's sagittal plane, which deflection will occur in either the medial or lateral direction. In conventional systems, this torque will tend to put stress on the interface between the bearing and whatever vertical structure to which the bearing is mounted. This stress may prematurely wear at that interface over time, causing early failure. Additionally, mounting a bearing and pulley to one side or the other of a vertical member, as is found in conventional systems, will tend to cause the member itself to deflect. Preferred embodiments of the invention overcome this conventional difficulty by mounting the bearing 562 within a rigid, tubular member that is sufficiently stiff to resist deformation when the bearing is subjected to torque that would otherwise cause its associated pulley 564 to deflect out of the vertical plane. This is accomplished by, for example, choosing a stiff geometry for the member 554 (e.g., a square, triangular, hexagonal, or some other tubular geometry having a closed, circumferential cross section), arranging the bearing 562 along a centerline of the tubular member such that the walls of the member are arranged both sides of the interface, and otherwise surrounding the bearing-member interface (i.e., above and optionally below) with sufficient material to allow the pulley to resist deflection. It will be appreciated that inventive embodiments accomplish this, while accommodating rotation of the pulley, with a special design of member 554 and pulley 564, which will now be described.

As is described immediately above, the center of bearing 562 is arranged within rigid member 554, with the long axis of the rigid member 554 running through bearing 562, such that bearing 562 is supported on a lateral and medial sides by walls of member 554. This arrangement reduces torsional forces on the rigid member when the lower hinged assembly 516 is actuated by one the cables 546, 548. This arrangement also permits the bearing-pulley assembly to resist torsional forces tending to deflect it with respect to the member. The interface between the bearing/pulley and the member is made stiff and strong, in part, by surrounding that interface with the walls of member 554, both above and below the medial-lateral through hole, which is provided for mounting the bearing.

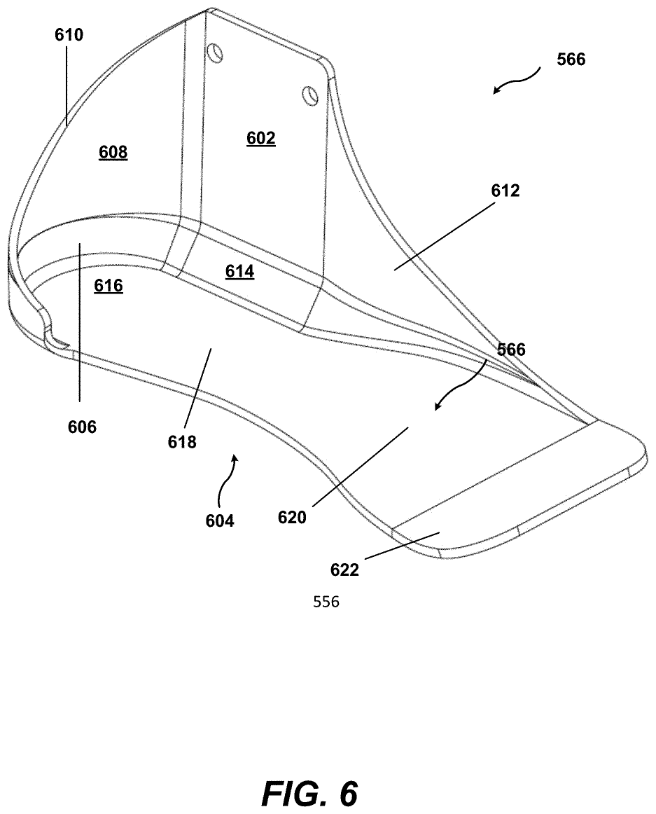

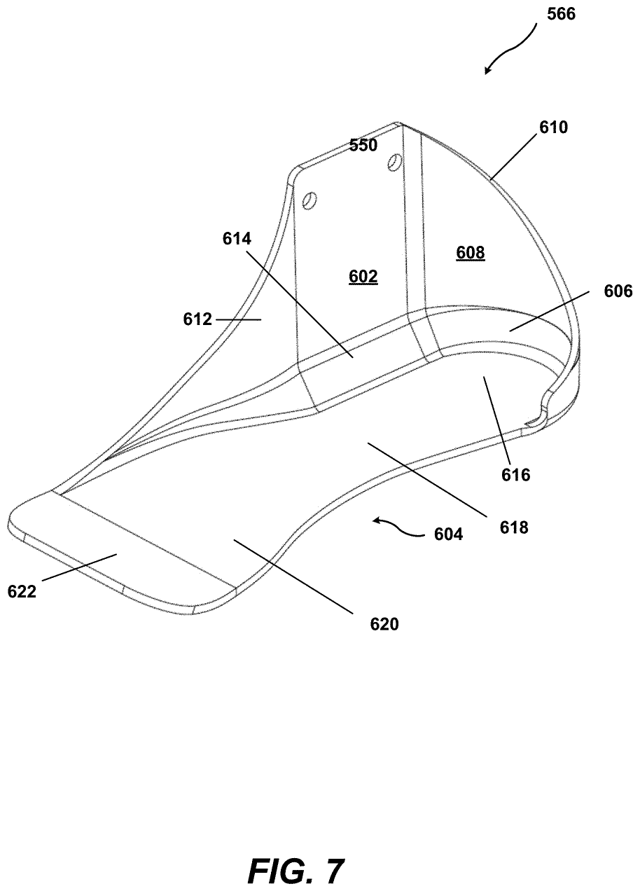

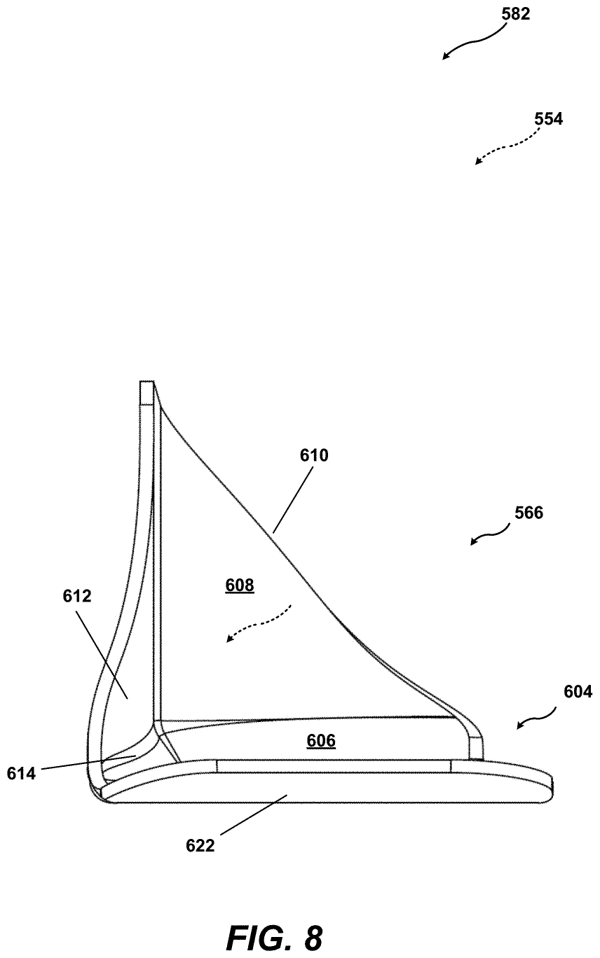

Referring now to FIGS. 6-9, there is shown a foot plate 566 according to one embodiment of the invention. Foot plate 566 is usable with the assistive devices depicted above, for example, in FIGS. 5. Foot plate 566 includes a vertical mounting portion 602, which when the device is worn, is arranged on a lateral side of a user's ankle, as shown in FIGS. 10 and 11. Foot plate 566 may be assembled into lower hinged assembly 516 by attachment of vertical mounting portion 602 to fixture 580 as shown in FIG. 5. Vertical mounting portion 602 may include through fastener holes, as shown, for this purpose.

Foot plate 566 includes foot bed 604 which is coupled to vertical mounting portion 602 such that it is substantially orthogonal to mounting portion 602 (i.e., substantially horizontal with mounting portion 602 is vertical), and extends away from mounting portion in a medial direction. Foot bed 604 includes a heel portion (616), a mid-foot portion (618) and a forefoot portion (620) sized and shaped to comfortably engage and support those areas of a wearer's foot. The size of foot bed 604 will vary depending on the wearer, but foot beds having a forefoot width of between 75-115 mm, a mid-foot width of between 30-60 mm and a heel portion width of between 40-70 mm have been found to be capable of accommodating the foot shapes of most users.

At a posterior side, foot plate 566 includes a curved heel cup 608 configured to wrap around and engage the posterior and posterior lateral sides of a user's heel. The heel cup extends vertically to a shoulder portion 610, which connects vertical mounting portion 602 to the heel portion 616 of foot bed 604 at a posterior medial side of the heel portion of the foot bed. Heel cup 608 also includes a transition region 606, which forms a connecting transition between the vertical portion of the heel cup and the heel portion of the foot bed. In certain embodiments, the interior facing surface of the heel cup transition portion (i.e., the surface facing the heel which may engage the heel during use) is rounded to accommodate the shape of the user's heel. In alternative embodiments, this surface is flat in cross section (i.e., in sagittal cross sections), although curved about a vertical axis. In the embodiments of the figures, the heel cup transition region's heel facing surface is a compound curve that is concave when sectioned by a plane parallel to the sagittal plane, and also curved about a vertical axis (e.g., an axis parallel to the long axis of vertical member 554. In certain embodiments, this surface may be approximated by a section of a hemisphere.

The height of the vertical mounting portion 602 from the plane of the foot bed 604 varies depending upon the user, but is preferably set such that when foot plate 566 is assembled to fixture 580 (and therefore to bearing 562), the user's ankle is aligned and collinear with the axis of rotation of bearing 562. In some embodiments, the high side, or lateral side of heel cup, where it engages the vertical mounting portion, will typically range from 3 to 10 cm in height from the foot bed, while the low side, or medial side of the heel cup will range from 0 to 3 cm from the foot bed.

The heel cup provides several advantages over planar foot plates (e.g, insole brackets 66 described in reference to FIG. 1). First, by engaging the heel at least partly on the heels posterior lateral sides, the heel cup tends to prevent the user's heel from twisting about a vertical axis, thereby keeping the motion of the feet in a plane parallel to the user's sagittal plane. Additionally, by providing vertical engagement with a posterior surface of the heel, the heel cup tends to prevent the user's foot from rotating up and out of the heel plate during walking, and especially during the toe off portion of the gait cycle, when toes are flexed and in contact with the ground, but the heel has come off the ground. Additionally, the heel cup serves to strengthen the overall foot plate to prevent both medial-plantar deflection (i.e., rotation of the footplate in an inward-down direction), and rotational deflection, or tendency to twist about the vertical axis (e.g., an axis parallel to the long axis of vertical member 554).

Foot plate 604 also includes a gradual forefoot shoulder or transition region 612, which is certain embodiments is a web of material that connects vertical mounting portion 602 to foot bed 604 in the region anterior to vertical mounting portion 602 and a lateral side of the user's foot. Forefoot shoulder 612, in the illustrated embodiments, has a top edge that defines a smooth curve from the top of vertical mounting portion 602 to the forefoot portion 620 of foot bed 604. Gradual forefoot shoulder 612 helps to strengthen and stiffen the overall structure of foot plate 604.

Foot plate 604 also includes lateral transition region 614, which includes a medially facing surface that interfaces with a laterally facing surface of the user's foot, just anterior to the heal, in the vicinity of the mid foot. The medially facing surface of transition region 614 is shaped to conform to the curvature of a user's foot, and may be either planar or concave toward the user's foot, like the interior facing surface of heel cup transition region 606.

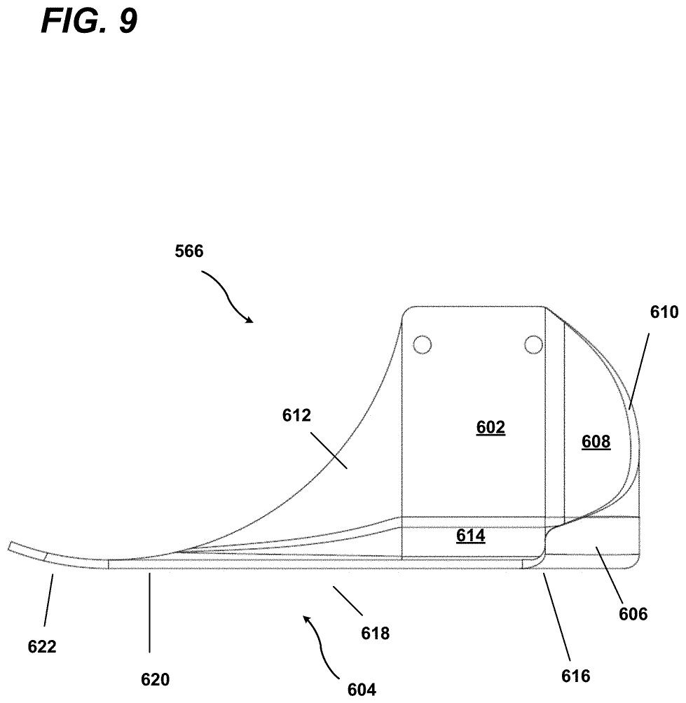

The foot bed 604 also includes an upwardly sloped toe region 622 anterior to the forefoot region 620. The upwardly sloped toe region 622, best seen in the side view of FIG. 9, is arranged to slope upwardly (dorsally) relative to the rest of foot bed 604, which is otherwise planar. In the illustrated embodiments, toe region curves smoothly upwards, but in alternative embodiments, toe region 622 is planar, but makes a non-zero angle with the rest of foot bed 604. In certain embodiments, a line connecting the transition between forefoot region 620 and the upper, distal end of toe region 622 makes an angle of between 5 and 15 degrees with the plane the other regions of the foot bed 604 and in particular forefoot region 620.

The linear extent and the angle of upwardly sloped toe region 622 will generally depend on the user's anatomy, but preferably, it is sized to accommodate toe dorsiflexion during the toe-off portion of the gait cycle, as seen in FIG. 10. That is to say, the linear extent and the angle of the toe region 622 is preferably chosen such that during toe off, the user's toes can be flexed and positioned to exert force on the ground (i.e., through the foot plate and any intervening shoe), without the heel or the sole rotating up and out of contact with the foot plate. This, again, is shown in FIG. 10, where the upwardly sloping toe region introduces rocker to the foot bed, and permits the entire foot bed to rotate forward during the propulsive stage of the gait cycle, without the user's foot coming off the foot bed.

Preferably, foot bed 604 is configured such that the transition between the planar forefoot portion 620 and the upwardly sloped toe portion 622 occurs in the vicinity of the distal ends of the user's metatarsal bones, which is the region that defines the first major joint of the toes. In certain embodiments, this transition occurs across a straight line that is perpendicular to a sagittal plane that includes the foot. The location of this transition may be set as the position of the average location of distal ends of all the metatarsals. In other embodiments, it may be set as the position of the end of the first metatarsal. In other embodiments, however, this transition may be angled relative to a long axis of the foot, because the end of the first metatarsal (for the big toe) is farther away from the heel than the end of the fifth metatarsal (for the little toe). In other embodiments, a complex shape may be generated such that the transition region matches the distal end of each of the metatarsals. Additionally, in certain embodiments, the distal end of the foot bed 604, defined by the distal end of the toe section 622, is a straight, blunt end that is perpendicular to the long axis of the foot. In other embodiments, this end may be curve. In yet other embodiments, this end may be angled with respect to a long axis of the foot such that it extends farther to provide engagement below the big toe, but not as far, because the little toe does not require as much length for engagement. Generally, it is preferable to configure the linear (anterior) extent of toe portion to engage the bottom of all the toes, and to slope it upward to accommodate natural toe deflection, but to otherwise limit its extent to reduce overall weight of the foot plate 566.

Referring now to FIG. 5, in certain embodiments, pressure sensor 576 is arranged across the transition between forefoot portion 620 and toe portion 622, to measure pressure applied by the foot to the foot bed across both these regions. In other embodiments, pressure sensor 576 is arranged on toe portion 622 so as to only measure pressure applied to the foot bed in the upwardly sloping toe portion 622. In yet other embodiments, pressure sensor 576 is located anterior to the transition such that it measures pressure near the transition, but entirely in the forefoot region of the planar foot bed.

In certain embodiments, foot plate 566 is composed of multiple layers of bidirectional carbon fiber oriented to ensure collinearity of fibers and external loads on the foot plate. Carbon fiber is advantageous due to its high strength to weight ratio, stiffness and the ability to form complex geometries. The use of carbon fiber or equivalent materials allow for realization of a light, thin, unobtrusive foot plate insole, that still provides the strength and durability necessary for high torque applications. Additionally, the material stiffness of carbon fiber results in minimal shank interface rotation. Additionally, carbon fiber's ability to be formed into complex geometries allows for carbon fiber foot plates to integrally include a heel cup, a gradual forefoot shoulder or transition region between the vertical mounting portion and the foot bed, and the upwardly sloping toe portion of the foot bed. The heel cup, as stated above, supports minimal rotational deflection and provides additional strength and rigidity in the coronal plane. The gradual shoulder, which connects the ankle portion to the sole portion of the footplate with a gradual curvature, supports minimization of stress concentrations. The combination of these features, as well as the material properties below, results in a foot plate structure capable of resisting torsional deformation. Structures described herein, when used in connection with the assistive device described in reference to FIG. 5, exhibit no more than no more than 10 degrees of axial twist (resulting in out of plane torque application) when up to 150 Nm is generated at the ankle joint.

Moreover, the curved forefoot feature, or upwardly curved toe region, allows the footplate to roll forward during user toe off, effectively adapting to the acute angle created between the toes and the forefoot during the propulsive phase of gait. As is set forth above, this is accomplished without shortening the footplate, which would move the assistive or resistive center of pressure posterior to the user's biological center of pressure.

Many of the advantages described immediately above are evident in FIGS. 10 and 11, which shows the orientation of a user's foot on a foot plate assembled to an assistive device according to an inventive embodiment. As can be seen, the foot plate of the illustrated embodiment permits the user's toes to flex and apply force downward, during the propulsive, toe off stage of the gait cycle, without the heel coming off the foot plate, and while maintaining flush contact between the food bed and the sole of the foot. The foot plate of the illustrated embodiments is also sized to fit unobtrusively within a user's shoe, as shown in FIG. 11.

While the thickness of a carbon fiber footplate that advantageously resists torsional deformation will vary depending on the weight and anatomy of a user, it has been discovered that a carbon fiber foot plate according to the illustrative embodiments having a thickness of between 2 and 6 mm in the foot bed, between 2 and 8 mm in the region of the heel plate, between 2 amd 8 mm in the heel and lateral transition regions, and between 2 and 8 mm in the area of the gradual shoulder yield good results.

In certain embodiments, the food bed may include recessed linear channels in its upward facing surface for routing of sensor cables, such as the sensor cables shown in FIG. 5.

In certain embodiments, the foot plate is formed of a carbon fiber core encapsulated, on one or all sides, in a layer of thermoplastic, fiberglass or other material such as rubber or silicon. In cases where thermoplastic is used as the outer material, such embodiments may be fabricated by a thermoplastic overmolding process using a carbon fiber mold insert. Such embodiments are advantageous because they permit ergonomic shaping and sizing of the overmolded portion of the foot bed to match the anatomy and size of a user's foot. In such embodiments, and in other embodiments described herein, the dorsal surface of the foot bed posterior to the upwardly sloping toe portion may not be planar, but instead, may resemble an orthotic insole shaped to match the ventral contours of a user's foot.

While in certain embodiments, the thickness of toe region 622 is the same as the other regions of foot bed 604 (i.e., 620, 618 and 616), this is not a requirement. In certain embodiments, toe region 622 is made thinner to improve its flexibility relative to the rest of the foot bed.

While the disclosure thus far has referred to a foot plate 566 usable with a powered exoskeleton, which itself is usable for assisting with walking, or for resistance training, the invention is not so limited. It will be appreciated that the foot plate described may also be used in passive devices such as braces, unpowered assistive devices that rely on springs, walking casts, splints, or the like. The foot plate described may improve any device that requires engagement of a user's foot during all stages of the gait cycle.

Use of the present disclosure may offer a variety of advantages, which is provided by various combinations of the features provided herein. For example, the exoskeleton device provided herein may provide assistance to any number of joints of a user. Moreover, the assistance or resistance may be provided in a real-world environment, versus just in a lab. The exoskeleton may be minimally invasive to the user during day-to-day activities and manufactured at substantially reduced costs compared to various other assistance devices that are commercially available. The exoskeleton may provide assistance during some modes of operation specifically intended to improve mobility or posture. Additionally or alternatively, the exoskeleton may provide resistance a mode of operation designed to increase muscle recruitment during a function task (e.g. walking). The exoskeleton provided herein may be coupled with a feedback modality that allows for feedback regarding use of the exoskeleton device. For example, the user modality may alert a user when various performance goals are met. In addition, the exoskeleton may be remotes coupled to an electronic device. The electronic device may obtain data regarding the exoskeleton device and/or provided controls for altering usage of the exoskeleton device. In addition, the exoskeleton device may include one or more algorithms for intermittently adjusting the assistance level of the exoskeleton device based on the user performance. The assistance level may be changed from an initial assistance level that is obtained through various methods provided herein that make it quicker and more obtainable for a user with gait deficits to be fitted with the exoskeleton device.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

It is also important to note that the construction and arrangement of the elements of the invention as shown in the examples are illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

The exemplary structures disclosed herein are for illustrative purposes and are not to be construed as limiting. In addition, variations and modifications can be made on the aforementioned structures without departing from the concepts of the present invention and such concepts are intended to be covered by the following claims unless these claims by their language expressly state otherwise.

The invention claimed is:

1. A foot plate for an assistive device, comprising:
a planar vertical mounting portion arranged on a lateral side of an ankle of a user;
a planar foot bed portion having a heel portion at a posterior end, a forefoot portion at an anterior end, and a mid-foot portion between the heel and forefoot portions, the foot bed also having a dorsal surface arranged to be orthogonal to planar vertical mounting portion;
a heel cup at the foot bed's posterior end, the heel cup having a curved surface that is concave toward the anterior end of the foot bed; and
a shoulder portion arranged on a lateral side of the foot bed, the shoulder portion connecting the vertical mounting portion to the forefoot portion of the foot bed.

2. The foot plate of claim 1, wherein the heel cup includes vertical portion and a curved lower transition portion connecting the vertical portion to the heel portion of the foot bed, the curved transition portion being concave, and having its concave curvature centered on a region toward and above the anterior portion of the foot bed.

3. The foot plate of claim 1, wherein the heel cup's curved surface that is concave toward the anterior end of the foot bed is configured to engage a posterior and posterior lateral surfaces of a user's heel.

4. The foot plate of claim 3, wherein the heel plate's vertical portion includes an upper edge having a high side connected to the vertical mounted portion, and sloping to a low side connected to the heel portion of the foot bed.

5. The foot plate of claim 1, wherein the vertical mounting portion is connected to the foot bed through a transition portion having an upward, medially facing curved surface configured to engage a lateral surface of a user's foot.

6. The foot plate of claim 1, wherein the foot bed is hour-glass shaped, having a long axis, wherein a width of the heel portion of the foot bed and a width of the forefoot portion of the foot bed both exceed a width of the mid-foot portion of the foot bed when measured transverse to the long axis.

7. The foot plate of claim 1, wherein the heel, mid-foot and forefoot portions of the foot bed all have dorsal surfaces that are coplanar, defining a dorsal plane of the foot bed.

8. The foot plate of claim 7, wherein the foot bed includes a toe portion arranged anterior to the forefoot portion, the toe portion have a dorsal surface that slopes upwardly with respect to the dorsal surface of the forefoot portion of the foot bed.

9. The foot plate of claim 8, wherein the dorsal surface of the toe portion is planar.

10. The foot plate of claim 9, wherein the dorsal surface of the toe portion makes an angle of between 5 and 15 degrees with respect to the dorsal surface of the forefoot portion.

11. The foot plate of claim 8, wherein the dorsal surface of the toe portion is curved and concave upward.

12. The foot plate of claim 1, wherein the foot plate comprises carbon fiber.

13. A wearable assistive device, comprising:
an extended, tubular structural member having a closed circumferential cross section, a first end and a second end defining a long axis through a center of the extended structural member;
a rotational bearing disposed within the extended structural member and positioned on the long axis near the second end of the extended structural member;
an extension cable having a first end coupled to an actuator and a second end coupled to the rotational bearing; and
a retraction cable having a first end coupled to the actuator and a second end coupled to the rotational bearing;
wherein, when the extension cable is pulled toward the actuator, the rotational bearing experiences a torque that tends to rotate the rotational bearing in a first direction; and
wherein, when the retraction cable is pulled toward the actuator, the rotational bearing experiences a torque that tends to rotate the rotational bearing in a second direction;
a foot plate coupled to a medial side of the rotational bearing and dimensioned to support the foot of a user, the foot plate comprising:
a foot bed having a planar dorsal surface, the foot bed extending medially from the rotational bearing and the structural member;
a heel cup having a curved portion arranged at an anterior side of the foot plate, and extending vertically up from the dorsal surface of the foot plate.

14. The wearable assistive device of claim 13, further comprising:
wherein, when the rotational bearing experiences a torque that tends rotate the rotational bearing in the first direction, the foot plate exerts a torque on an ankle of the user that assists dorsiflexion of the foot of the wearer and opposes plantar flexion of the foot of the wearer; and
wherein, when the rotational bearing experiences a torque that tends to rotate the rotational bearing in the second direction, the foot plate exerts a torque on the ankle of the wearer that assists plantar flexion of the foot of the wearer and opposes dorsiflexion of the foot of the wearer.

15. The device of claim 14, wherein the foot bed comprises a planar dorsal surface configured to support at least the heel and mid-foot of a user, and an upwardly sloping toe portion having a dorsal surface that makes an upward angle with the planar dorsal surface.

16. The device of claim 15, wherein the upwardly sloping toe portion's dorsal surface is curved and upwardly concave.

17. The device of claim 16, wherein the foot bed has a transition region between the planar dorsal surface and the dorsal surface of the toe region, and wherein the transition region is configured to occur in the vicinity of distal ends of the metatarsal bones of a user wearing the device.

18. A foot plate for an assistive device, comprising:
a planar vertical mounting portion arranged on a lateral side of an ankle of a user;
a planar foot bed portion having a heel portion at a posterior end, a forefoot portion at an anterior end, and a mid-foot portion between the heel and forefoot portions, the foot bed also having a planar dorsal surface arranged to be orthogonal to planar vertical mounting portion;
an upwardly sloping toe portion, anterior to the to the forefoot portion of the foot bed, the upwardly sloping toe portion having a dorsal surface that slopes upwardly away from the planar dorsal surface of the foot bed.

19. The foot plate of claim 18, wherein the upwardly sloping toe portion's dorsal surface is planar.

20. The foot plate of claim 19, wherein the upwardly sloping toe portion's dorsal surface is curved.
